(19) United States
(12) Patent Application Publication
(10) Pub. No.: US 2017/0091843 A1
(43) Pub. Date: Mar. 30, 2017

(54) DIGITAL MARKETPLACE NETWORK CONNECTING CONTENT PUBLISHERS DIRECTLY WITH END USERS/CONSUMERS

(71) Applicants: Lucien Michael Zeigler, Arlington, VA (US); William Murray Treadway, Houston, TX (US)

(72) Inventors: Lucien Michael Zeigler, Arlington, VA (US); William Murray Treadway, Houston, TX (US)

(73) Assignee: OUTL!T INFOMARKET, LLC, Arlington, VA (US)

(21) Appl. No.: 14/872,048

(22) Filed: Sep. 30, 2015

(51) Int. Cl. G06Q 30/06

(52) U.S. Cl. CPC G06Q 30/0601

(57) ABSTRACT

One or more embodiments provides a way for humans, computers, companies, or other entities to produce content and directly sell it to consumers, the process of which comprises a marketplace. Thus, one or more embodiments enables content to be created and sold on a single platform. The embodiments optionally have content from a variety of content producers, which can be browsed and purchased by consumers or end-users directly from the producer, thus creating a virtual marketplace for digital content. One or more embodiments include optional computer-implemented social networking features, ways for consumers to subscribe to selected and selectable content, means for consumers to aggregate content, means for consumers to aggregate login credentials, ways for consumers to preview content, means to calculate a price automatically for content, ways to prevent copying of content using normal computer text copying means, means to securely access content, and other features.

### CROSS REFERENCE TO RELATED APPLICATIONS

This application claims the benefit of provisional patent application Application No. 62/057,258, filed 30 Sep. 2014 by the present inventors.

### SEQUENCE LISTING OR PROGRAM

A copy of the code implementing one or more embodiments described herein is attached as one or more ASCII text file(s) and incorporated herein by reference.

### BACKGROUND

The terms “invention, the invention, this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

It is difficult for an individual, small-to-medium sized content sources, and even large entities to generate revenue for their digital content, especially written content, regardless of how valuable it is. We have found that there are two main hurdles which make it difficult if not impossible for individuals or other content creators to earn money from their content on the internet: 1) the ease of publishing, in other words, getting writing and pictures onto the internet, and 2) the ability to earn for that content directly. These hurdles exist for both the content producer—i.e. the writer, or agency which they represent, as well as the consumer who would like to consume this content. Neither producer nor consumer currently has a single online node to produce, consume, and discover each other. One or more embodiments we disclose herein ameliorates that deficiency.

Difficulties of Digital Publishing and Earning From this Publishing

One reason why it is hard to publish what one desires on the internet is the difficulty of setting up an individual blog or website, which requires advanced technical and design skills, domain registration, and recurring hosting costs. The ability to take the content itself—the written word and any images one would like to include with it—and format it in a pleasing way is beyond the technical expertise of most writers. Although some websites exist which to some extent mitigate the barrier for one to quickly publish material, for example, Wordpress or Twitter, there are inherent limitations to these methods. First, many of these services do not serve as a centralized repository for a variety of content. For example, individual bloggers might have their own Wordpress site for their content, but it is not proximate to other content or easily discovered since it is separated on the blogger's own site. While sites like Twitter allow all voices to be heard as organized in a centralized area, this is not a realistic option for writers who want to compose literary pieces or share more than a quick thought. Furthermore, these thoughts get quickly washed out by the “latest and greatest” and lost in a sea of digital shouting with only hashtags to help navigate the chaos.

Beyond the technical and logistical difficulties in publishing written work online, the underlying problem of earning from one's writing is not solved by any of these sites, except to erect a digital “paywall” in the form of paid subscriptions, to include advertisements alongside the content, or to ask the unmotivated consumer to donate of their own volition. Thus, the content creator now has to manage subscriptions or advertisements in order to collect revenue, when all they want to do is produce content; alternatively, the content producer can spend their creative talents imploring the consumer to donate with a well phrased and moving message, thereby distracting the content creator from their original creative task. Managing monetization strategies takes logistical, creative, and technical expertise beyond that required to simply publish content. For example, one might have a good mastery of HTML and CSS, enough to create a website to write what they would like (and format it in a pleasing way), but have no idea how to set up a payments collection system, manage advertisers, manage subscriptions, market their site, etc. Third party services are frequently used to help content producers use these limited strategies to earn revenue, but negotiating and managing these relationships again requires additional skill, expertise, and time, which distracts the artist or writer from their main task. Meanwhile, their content is cluttered with pop-up advertisements, banners, and audiovisual advertisements which are distracting.

Especially when viewed from the consumer's perspective, yet another reason why it is hard for producers to generate revenue for online content is the disconnectedness of similar content and like publishers with one another, along with a difficulty for the consumer to find the content they are interested in among a sea of other content which does not strike their fancy. While there are certain websites, apps, and services which will curate content based on pre-set interests, these websites are not integrated with the websites which offer the content directly and therefore yet another obstacle exists between to creating a harmony of publishing content easily, paying for content easily, and organizing and sorting content easily.

Likewise, it is cumbersome and costly for users to consume written content, especially high quality content that a consumer will be interested in. One reason why it is tough for consumers to obtain high quality content is that much of this premium content is largely only available on a buy-it-all basis; meaning, one must subscribe to all content provided by a given content source, rather than each piece of content (e.g. written article) being available as an individual unit. To date, premium content providers such as the New York Times or content providers with premium access levels such as ESPN.com's INsider may offer a handful of “free” articles before one must pay for any and all articles thereafter; in essence, once a subscription is purchased, the consumer pays for a good deal of content which they do not want or need. Thus, a consumer interested in a certain selection of content from a large publisher must pay for all of the content from that publisher. The problem can become more specific with respect to an individual writer's content. One may be interested in reading only a single piece by a given author, yet that author may have a subscription-based blog. Therefore, the consumer must pay for all of the content by that author in order to read the single piece in which they are interested.

Another reason it is difficult for consumers to obtain high quality digital content is because one subscription typically only provides content from a single source. While there are some subscriptions which “bundle” one or more content providers, still the consumer is subscribing to a great deal of content which they do not need nor want, while still not having access to all of the content they do want or need. Moreover, bundled subscriptions may be subject specific, whereas content representing disparate interests (e.g. gardening and fantasy football) are rarely and simply bundled together. Yet another reason why it is difficult for consumers to obtain high quality content, especially via subscription, is that users must maintain login names, passwords, and other personal information on multiple sites, many of which have differing requirements with regard to password length, available usernames, login maintenance frequency, and varying levels of user information security. Even the most saavy person finds it difficult to keep track of their online credentials at the wide variety of sites which require them.

Difficulties Earning from Digital Publishing Directly

Along with the issues discussed above, current revenue models for online content are tangential to the content itself. In other words, the content is not what earns for the content producer, but instead the volume of web traffic (i.e. readers) who pass through or who subscribe to a site. As an example of what we mean, take a look at the recent proliferation of “clickbait”-type links on websites, examples of which are provided here:
“You'll never believe how this single mom saved thousands on her mortgage.”
“One easy trick to lose 10 pounds”
“18 Celebrities with criminal records: #12 will shock you!”
   And so on. The digital content which should serve as the source of its own intrinsic value is instead marginalized. The only means to monetize any content is web traffic itself (i.e. the numbers game of subscriptions or site visits leading to advertisement clicks). This incentivizes content producers to produce flashy, tempting headlines and/or pictures, without rewarding them for production of quality content which is truly satisfying to the consumer.

Additionally, both the subscription- and advertisement-type models do not reward for individual pieces, but rather for the aggregate of the content producer's offerings. Unless one is truly prolific, subscriptions are difficult to justify since the amount of content—really, the amount of content that any given reader would find interesting—can't be justified against the cost:quantity balance of the subscription. In other words, unless a user finds available to them a vast choice of content, they are less motivated to subscribe to a source. Moreover, as more content is offered, end-users are more motivated to subscribe, but the less likely it is that an end-user will be able to consume all of the content. Hence, publications (newspapers, magazines, etc.) bring together a wide variety of content for readers, who now have a varied buffet of content from which to choose. Nonetheless, the consumer often pays for more than they get, out of this necessity.

The growth of targeted advertisements—whether the user has subscribed (i.e. already paid for) the content which they are consuming—shows that advertisers know that consumers have a selective preference for certain types of work. Thus, while one may find a truly rewarding and stimulating article, for free, the advertisements surrounding said article are a numbers-game. This numbers game comes at a cost to most consumers—specifically, the culling and collection of personal and semi-personal data in order to operate the algorithms that create those valuable targeted advertisements. And, while the customer may not pay for it in currency, they pay for it in distraction, irritation, loss of privacy and valuable time. The more of those articles the user sees, the more advertisements, the higher the likelihood of clicking the advertisements, and therefore the content production which serves as the bait for all of this traffic becomes a sheer volume play. Meanwhile, that one article which is truly the focus of the reader may have required substantial effort and time on the part of the writer, but these high quality pieces are less favored in the current market conditions than the same use of time to produce a large volume of superficial content which increase site traffic.

Consumers have gotten so used to the proliferation of ads, and frankly, tired of being harassed by the ads, that many have installed ad-blocking software integrated into their web browser. This ad-blocking software provides something consumers apparently desire—“clean” and non-distracting reading experiences, but does not fulfill the needs of content producers, namely, making money from their work. Thus, the difficulties of earning from digital publishing, directly, have become even more substantial as of late.

Prior Art and Limitations Thereof

One approach which recently has gained some traction among Dutch speakersis Holland-based Blendle. Operating in the Netherlands, and recently expanding into Germany, Blendle allows users to pay for individual news articles. While this approach has merit, there are several limitations which do not resolve all of the issues as described above, and which bring about their own sets of issues we have discovered:
1) There is no way for individuals to write and publish on Blendle.
2) Blendle simply takes a selection of articles from various news producers and sells them. The complete content from any one publisher is typically not available.
3) Blendle is not available in English.
4) There are no methods available to subscribe to a given source or type of content, since (#2) the full content from a given publisher is not available and sorting by type of content is unavailable (e.g. sports).
5) Blendle has advertisements.
   Blendle has limited user-to-user interaction between users, let alone a social network amongst them on the site.
It is undeniable that, in the age of digital media, traditional print journalism sources are struggling. Many have gone out of business entirely, and others have had to take drastic action (viz. the New York Times' paywall) in order to keep afloat.Newsroom layoffs, downsizing of foreign coverage, mergers and acquisitions, and budget cuts have become the normal modus operandi for many publishers. While pundits have discussed the idea of individual payments for articles of news and journalism, their vision stopped there. We have been able to figure out how to implement this system and address problems as they have arisen, for example:

How much should one charge for each article?

One solution we determined is to let the content producer decide, i.e. the author. This enables content producers to compete in a capitalistic sense by setting a vlue to balance supply (and quality of that supply) to demand. Alternatively, based on word count, average length of words and sentences, number of pictures, and other metrics, algorithms are easily used to determine value, especially in context of other articles being purchased.

Will consumers find this convenient?

We have found that by having all articles in one place, content is much more conveniently accessed versus having to use multiple websites. Moreover, consumers save time and distraction.

Why would someone pay for an article which they can get for free elsewhere?

We have found that consumers want instant gratification and are willing to pay for it, versus the hassle of finding another version of an article. Moreover, for unique articles and written content, for example, a copyrighted short story, there is only one place to find it. It is convenient that those stories, blog entries, opinions, recipes, etc., are alongside the news that a consumer wants to know in any case. Finally, even if a consumer can find an alternative source for a given piece of content, that content might be surrounded by advertisements, contain embedded cookies, cause popups, and other distractions that make it not worth it for the consumer.

How can micropayments work?

We have found that by allowing users to enter credit card information and put money into a virtual account, the barrier to spending has been lowered versus having to re-enter financial information each time. Allowing said virtual account to automatically re-augment itself from the source of money (e.g. automatically debit a credit card or Paypal account) makes the process seamless for the user. In current times, we have discovered that pennies, nickels, and dimes are not a barrier for most consumers to instant gratification. This is in contrast to Blendle, which might charge upwards of a Euro (i.e. depending on conversion rate, more than a dollar) for a single article.

Will users pay for something without knowing what it is?

It is well known that many people will go see, rent, or pay-per-view a movie which they eventually do not like, yet movies remain a very profitable enterprise. We have found that giving a portion of the content for free to indicate to the consumer what the content is about helps to entice users as well as indicate whether they would find the content worth the price they would pay. It is a unique approach we discovered for written pieces. In addition, in one or more embodiments, providing an article word count, and the option for a user to receive a refund if they are unhappy with the content they have purchased gives users the peace of mind to go ahead and pay for the content.

In addition to these problems which we have discovered and developed solutions fore, we have realized that much of the most valuable content—the content that consumers would pay for and which would earn for writers—is neither news, nor journalism, but might be classified as opinions, blogs, musings, predictions, visions, religious and philosophical writings, fictional pieces (including short stories or novel chapters), erotic writings, historical notes, and so on. This finding is in stark contrast to the model of operation of Blendle, which only has selected news and none of the other content listed above. This is not to say that news and journalistic writings do not have value, but they are far from the only type of content for which consumers will pay. As a historical example, note that Arthur Conan Doyle and Charles Dickens wrote periodicals for their local newspapers which drove sales. Unfortunately, users had to buy the entire paper just to read the latest update to their favorite authors' storylines. Dickens got paid by the word, to the chagrin of schoolchildren worldwide. If he got paid, instead, by the quality of the content, it may have made A Tale of Two Cities a much more terse (and possibly more readable) text.

Some newspapers are testing the pay-per-article content (see: http://www.niemanlab.org/2015/04/the-winnipeg-free-press-is-launching-a-paywall-that-lets-readers-pay-by-the-article/). While many of these are not prior art to this application, the basic idea of pay-per-view news was also proposed in 2009 in a Time article by Walter Isaacson (http://time.com/3270666/how-to-save-your-newspaper/) and so is prior art. These prior art are significantly different from the proposed idea, plus they do not address problems we have discovered and solved as discussed above and below:
The main difference between “pay-per-view news” and our embodiment(s) is the fact that our embodiments enable any person or entity to produce content on a site, and to then take that content and sell it in the marketplace (,including selling it for no money, i.e. giving it away for free—which we have discovered is a practical advantage to the operation of one or more embodiments). Having news be pay-per-article would not enable “the little guy:” e.g. bloggers, independent writers and journalists, freelancers, etc. the ability to produce content of their own accord and have it compete for consumer purchase in a marketplace. Blendle's implementation does not allow for any given person to produce and sell content, and additionally, does not have all content from any of their given sources. Instead, it is a selection of content that they have simply bought the rights to. This leads to the next shortcoming . . . .
Pay-per-article news would not bring together diverse voices, opinions, and sources in the way our embodiment(s) do. Our embodiment(s) level the playing field so that sources of various size, from an individual to a large organization can all have their content side by side. Moreover, on a practical level, we have realized that consumers will dislike the disparate logins, passwords, stored financial information, etc., which bog down the process of a user engaging with an article when multiple sources all have pay-per-view content. Having content from many sources in one place (as opposed to, for example, a variety of Wordpress blog sites or individual newspapers) would therefore have great value.
A problem the pay-per-article news has that we discovered and have developed at least one solution for is how to price a given piece of content. Quality is not simply based on word count, nor click count, as described in brief above. Moreover, an author might want to more broadly disseminate their opinion (in a true marketplace, as would be produced by one or more of our embodiment(s)) so the author would likely want to have control over the price of the content.
Another problem with pay-per-article news that we have realized and at least partially solved is the consumer resistance to being “nickel-and-dimed,” in other words, the constant reminder through so-called “micropayments” that each click costs them a few pennies. This problem was outlined as it relates to other uses of “micropayments” in an article by Clay Shirkey in 2000 (see: http://www.openp2p.com/pub/a/p2p/2000/12/19/micropayments.html), but we have realized its implications for digital content such as news articles, blog posts, written works, pictures, opinions, musings, predictions, visions, religious and philosophical writings, fictional pieces (including short stories or novel chapters), erotic writings, historical notes, videos, multimedia presentations, audio files, or any combination thereof. One solution to this problem, as mentioned, is to provide a good deal of free content for users. Another solution we discovered is to make what we call a “sub-subscription,” or “sectional subscription,” or “micro-subscription,” which allows users to pay a flat rate for a selection of content. However, this sub-subscription is not a selection necessarily made by a content source and which the content producer makes available on the site. In contrast, this may be a selection that the user themselves define: for example, a user might want all of the sports from a given newspaper, or any article that talks about politics. The user, in one or more embodiments, can create “filters” to automatically curate that information for themselves, and in one or more embodiments, opt to—as we call it—“unlock” that content, i.e. pay a flat rate for the privilege of accessing it all without paying for each piece of content individually. We have discovered that this is a desireable feature which we have incorporated in one or more embodiments. We have also discovered that taking this notion too far—i.e. a full subscription to a sources' content—puts the idea back in the place where pay-per-article seems more favorable. Thus, there is a balance between what a user can “unlock” and what they will pay for, a balance which our embodiments are aimed to create.

In addition to the above articles, the following is a tabulation of some prior art that presently appears relevant:

U.S. Patents

| Patent | Application | | |
|---|---|---|---|
| Number | number | Filing Date | Patentee |
| U.S. Pat. No. | 07/914,040 | Jul. 14, 1992 | Wyman, Robert M. |
| 5,204,897 A | | | (Kirkland, WA) |
| U.S. Pat. No. | 09/080,030 | May 15, 1998 | Verstis, Viktors; |
| 6,282,653 B1 | | | Himmel, Maria Azua |
| U.S. Pat. No. | 09/267,269 | Mar. 12, 1999 | Fucarile, Lori J. et. |
| 6,766,305 B1 | | | al. |
| U.S. Pat. No. | 09/564,456 | May 3, 2000 | Saw, Chit Wei et. al. |
| 7,020,781 B1 | | | |
| U.S. Pat. No. | 09/482,725 | Jan. 13, 2000 | Peinado, Marcus, et. |
| 7,136,838 B1 | | | al. |
| U.S. Pat. No. | 08/964,333 | Nov. 4, 1997 | Ginter, Karl L. et. al. |
| 5,982,891A | | | |
| U.S. Pat. No. | 07/874,991 | Sep. 21, 1993 | Sprague, Peter J.; |
| 5,247,575 A | | | Lipscomb, Thomas H. |

These patents deal primarily with the licensing of content from producer to licensee as well as means and methods for secure delivery and usage of information. These prior art deal with royalty collection systems, methods to account for usage of content, a way to establish a trust relationship between the licensor and the device which displays the licensed content, a way to control, negotiate, and validate digital licenses, ways to purchase individual bits of secure information, and so on. While these prior art deal with the essential problem of taking content from one place and transmitting it to another, none deal with a direct method for a creator of content to easily sell that content to a user, nor a way for a creator of content to create said content.

U.S. Patents

| Patent | Application | | |
|---|---|---|---|
| Number | Numer | Filing Date | Patentee |
| U.S. Pat. No. | 10/032,751 | Oct. 27, 2001 | Vaidyanathan, Vijay; |
| 7,653,552 B2 | | | Kitze, Christopher Allin |

This patent deals with a marketplace for digital content. However, it fails to disclose a method for producing the content for sale directly within the marketplace. Instead, this method and system relies on the content owner to upload a file to the marketplace. Thus, the content must be separately produced and then uploaded, added, linked to, or otherwise included in the marketplace. This additional step creates hurdles for content producers who want to sell their ideas and creative thoughts. Moreover, it creates issues with formatting; one content producer might have formatting written in a given markup language which is incompatible with a given users mode of reading that content. This makes it difficult for the user to see the value of the content itself as they are distracted by the unfamiliar or unorganized formatting. Even more, this disclosure doesn't enable a content producer to instantly and quickly get content onto a marketplace but instead must separately create a file and then upload it. Thus, this disclosure does not provide the advantage of instantly and easily putting content onto the marketplace which, for example, might provide a crucial advantage if one is the first to report a given news event or breaking piece of information. The patent also includes resellers of content, which creates additional “middle men” for content, producing further barriers between the content producer and the end user. In contrast, an embodiment of our inventions enables the content producer to earn directly without so-called “re-sellers.” One embodiment of our application is the direct connection between producer and consumer, which creates additional benefits as discussed herein.

U.S. Patents

| Patent | Application | | |
|---|---|---|---|
| Number | Number | Filing Date | Patentee |
| U.S. Pat. No. | 08/570,510 | Dec. 11, 1995 | Goldhaber, A. |
| 5,794,210 A | | | Nathaniel; Fitts, Gary |

An easy way to understand this disclosure is as the inverse of one or more embodiments of the inventions under consideration in this patent application. Specifically, it deals with advertisers paying people to watch advertisements. In contrast, our application is aimed at consumers purchasing content that is made available on a marketplace on which content producers can produce their content. Moreover, one embodiment of our invention provides for the reduction or elimination of advertisements. U.S. Pat. No. 5,794,210 attempts to further propagate advertisements.

U.S. Patent Publication

| Publication | Application | | |
|---|---|---|---|
| Number | Number | Filing Date | Patentee |
| U.S. Pat. No. | 13/446,691 | Apr. 13, 2012 | Lemmons, Mark et. al. |
| 8,296,190 B1 | | | |

This patent deals with licensing of content. Our embodiments are concerned with the viewing and retrieval of information. In fact, in or more embodiments, licensing of content is strictly verboten since it is the intention of these embodiments to provide a means for publishers to publish but maintain the copyright and control of their work, while still dessiminating their creative content and earning money from it. Moreover, the U.S. Pat. No. 8,296,190 deals with licensing content but not a marketplace for similar content to be compared, the value of which can be assessed by end-users relative to similar content, thereby creating a supply and demand cycle for content. Additionally, although some embodiments might allow for end-users to negotiate price, in some of our embodiments, the price is set and not negotiable. Moreover, in some embodiments of our patent, we allow content to be viewed for free, and in still other embodiments, we allow for the use of creative commons license or other reuse with modification wherein the copyright or control over the license of the content is not maintained by any individual or entity but instead free for any or all to use. In still other embodiments, the ability to consume content is given away freely, while rights to the copyright or control of the content may or may not be maintained. Finally, the disclosure by Lemmons et. al. does not discuss the ability to directly publish on the site, as we disclose in one or more embodiments of our application.

U.S. Patent Publication

| Publication | Application | | |
|---|---|---|---|
| Number | Number | Filing Date | Patentee |
| US 20120271738 A1 | 13/536,242 | Jun. 28, 2012 | Narcisse, Allen; |
| | | | Momary, William |

This disclosure deals with management rights for digital content as a license. It does not deal with creating a marketplace to directly connect content creators and end users, nor does it apparently disclose methods or means for directly publishing using the platform itself. Instead, this disclosure assumes that transfer of rights or license to content from content producer will go to a publisher who will then be able to freely publish the information. Thus, the disclosure is incomplete relative to one or more of our embodiments.

Other Aspects of One or More Embodiments

One embodiment of our invention is the combination of a publishing platform for a wide variety of sources along with a marketplace to share and sell that content. Nonetheless, we recognize that in the current state of the industry, additional value can be had by inclusion of additional features and options which will make the experience of the entire product more user friendly for both the content producer as well as the consumer. Many of these features are well known in the art and common for internet users, while others are unique to certain embodiments.

One such feature added in certain embodiments is the inclusion of a “social network” as it is commonly understood today. This social network optionally has a variety of features, possibly including but not limited to:
Providing a way for users to create a profile which provides information about the user in the account if desired, including profile photo(s), text, external links, and so on, and to provide a list of content created by the user, or “clipped” by the user
the ability for users to “follow” each other
   to see their updates
   share and exchange messages and article previews or full articles
   share a preview of article content directly to other selected friends or contacts, and add original commentary or thought to the preview content
   regardless of whether the users are known to each other or not
the ability for a user to link to a preview of content for all friends, contacts, and the public to see and add original commentary or thought to the preview content
the ability for users to purchase digital content(s) in advance, then send that content (instead of a preview) to another user directly
   optionally, incorporating other features of the “social network” as discussed herein along with this “gift”
Reply directly to another user's comment
Creating lists of content that one has found valuable in order to share that content
   And so on. The usage and purpose of social networks are well known in the modern era, and the features which consumers are used to are easily included in one or more embodiments. As may be evident, one of the major advantages of embodiments incorporating social networks is the increase in proliferation of content, the publicity of content, and therefore the value of content both to the content producer as well as the end-user.

Another useful embodiment may allow users (both content producers or consumers or both) to aggregate content. This aggregation may have many useful features, such as
Through a variety of display arrangements, allowing users to browse previews of articles, including images, author by-lines, body text previews, and other media
Enabling users to see full articles of content, either because that content is free or by paying for content
Enabling users to share content previews on other social networks, or internally to other users of Outlit, as outlined above
Providing a way for users to customize their reading experience, including creating feeds of story previews from selected sources. This is achieved by “favoriting” or following a source, thus placing that source within a list of providers
Allowing users to create multiple versions of the above “favorites” lists, called “reading lists,” that, through the same function, gives the user the ability to create different lists based on interest, subject, or source selection.
Allowing users to search for content by topic, keyword, story title, or source and refine results by publication date, relevancy, and popularity, or by article price.
Allowing users to browse popular topics curated by one or more persons, or generated automatically by frequency of search queries from users, or any other means
Automatically bringing content from outside sources into the site so that a single user can access a wide variety of sources with a single login.

### SUMMARY

One embodiment is an internet-based platform to allow creators of digital content, such as writers or newspaper organizations the ability to publish and place that content into a marketplace that permits and facilitates the sale and purchase of content directly to end users, such as readers. In an embodiment, producers of online content place their digital offerings alongside other producers in the marketplace, and these producers (individuals or companies) may either choose to publish (allow consumers to read) content for free, or charge either by individual unit of content or periodic subscription to regular content directly to an end user. End users may, in one embodiment, manage these purchases or subscriptions to many sources with a single account and payment method, and may build a personalized feed of premium content comprised of varied sources. In another embodiment, users can procure subscriptions to only selected offerings from a given content producer, for example only the sports section of a given newspaper. End users collectively form, in an embodiment, a network, and may recommend free or premium content sources or individual units of content to others, comment and discuss with other users in the network, and share posts externally on other networks, along with other interactions familiar in the art.

### Advantages

We therefore have determined that a system which allows people to easily create and sell their content would be of tremendous value in the current digital publishing space. Such a system enables freelance writers, or any person, to earn a living for their creative endeavors. This system enables an entirely new economy by which people can buy and sell their creative work even without the normal access to institutions that have historically been required. For example, a writer could publish a book, chapter by chapter, allowing them to keep readers waiting for the next chapter release (versus the current model of readers waiting years for the next book in a series to come out). Other embodiments can increase the value of this model by allowing authors to engage directly with consumers, with each other, or consumers with consumers, to help promote and drive interest for a given piece of written content, and in the process add value to that content in the form of discussions, comments, and so on. Other embodiments which collect content, allows users to organize content, connects users to the information they want while being able to find new information easily, or allows content which would otherwise require a subscription to be purchased and sold a la carte can change the face of publication in the modern digital world.

We have also determined that in many cases, charging a relatively low, nominal fee for digital content does not present a barrier to people consuming (reading, seeing, purchasing and so on) the content, especially when the effort required to consume the content is identical (two clicks of a mouse, for example) whether the content is free or not. For example a newspaper article with 2,000 words on a news story from a credible and well regarded source such as the New York Times is worth a few pennies to most consumers versus a poorly written, non-credible, and poorly sourced article with only 150 words, even if the latter is free. Thus, one advantage of one or more embodiments is the ability to consume articles and content a la carte without a subscription, without dealing with content which does not interest the consumer or user. Another advantage of one or more embodiments is the collection of content across disparate sources in a single location. An additional advantage of one or more embodiments is the fact that content that is priced higher often will be considered to have higher value. As an analogy, consumers will often choose luxury cars, brand-name items, or other consumer goods having an air of exclusivity but inherently no additional value versus competitors items. Therefore, in one or more embodiments, having content priced higher than other similar content may lead to consumers to choose that content due to the perception of greater value. In yet another advantage of one or more embodiments, providing users a choice between content providers they know and trust, for example, and those they are more wary of provides value to both the consumer and the content producers selling their goods.

Other advantages of one or more aspects of the embodiments is the connection of users to one another, to the content they want, and by being connected to other users and content which interests them, the ability to discover new users, content, and content creators. Still other advantages of one or more aspects of the embodiments are the ability to easily create well formatted, organized, professional looking content and to easily sell this content.

Another advantage still is that in certain embodiments, the buying and selling of articles can replace the need for advertisements, which can be distracting from the content at hand for the reader and a difficult logistic problem for the publisher.

An advantage of one or more embodiments is the solution to previous failure by others. As discussed, but by way of an example, one way this solves failure by others is to provide a means for people to earn a living freelance writing without having to negotiate or otherwise deal with publishing firms, newspapers, magazines, editors, and so forth.

An additional advantage of one or more embodiments is the solution to an unrecognized problem. As more young people are attending college, more people graduate with literary degrees in English, journalism, creative writing, and so on. Many of these people may find it difficult to find work in their field due to the increasing supply of talent. However, one or more embodiments described herein allow these people, and others, to create their own jobs by using the talents they have spent years refining in schooling, training, or which may come naturally. Still another advantage is the unappreciated advantage of providing a means for people to feel confident about their prospects, which is an intangible benefit but one that will have a very real effect for people who want to pursue a career in writing or publishing, but who do not have the necessary means otherwise. Still another advantage is the creation of a space wherein others who may not be content producers can sell their services as editors, copyright agents, copy editors, language translators, and other ancillary jobs associated with writing and publishing.

Advantages of one or more embodiments also include the solution to a previously unsolvable problem. As discussed above, many consumers of online content have installed software that blocks advertisements in their web browser. These ad-blockers prevent popups, banners, side images and text, and other media from being displayed alongside the content of the website itself. This has created a heretofore unsolvable problem: the simultaneous meeting of the desires of the consumer to have a clean, ad-free, non-distracting experience with content, and the need for content producers to earn a living. One or more embodiments enable the direct exchange of money for content between consumers and producers, thus obviating the reasons content producers need ads, namely, the generation of income, while simultaneously satisfying consumers who want to have a distraction free experience with content.

Yet another advantage of one or more embodiments solves a seemingly insoluble problem developed by the nature of the publishing space itself; i.e., one or more embodiments solves what seems to be a self-fulfilling prophecy and previously unsolvable problem. The problem we recognized is that the user who finds it advantageous to subscribe to a content source with a wide variety of content will by definition increase the chances that some of that content is not of interest to the consumer; therefore, the consumer will almost always not consume all of the content for which they are paying. In other words, by necessity, the user who purchases a subscription to a given source of content is more motivated to do so because of the wide variety of content from that source, which inherently makes more likely that the user will not be interested in all of the content available. Moreover, even if the choice or subject matter(s) of content all align for a given user who subscribes to that content producer's offerings, typically that end-user's motivation to purchase a subscription increases in direct proportion to the amount of content available, which correlates with the inability for a user to consume all of said content, correlating to the increasing lost value to the end-user of paying for content they will not consume. In other words, more content availability by subscription increases both the chances of an end-user subscribing and the chance that at least some of content will not be consumed. One or more embodiments solve this problem by allowing end-users to only pay for the content they consume directly.

An additional advantage of one or more embodiments is the solution to an unrecognized problem. One issue with payments for individual pieces of content, viz. micropayments, is the feeling by the consumer of being “nickel and dimed” at every click of their mouse, for example. However, on the other end of the spectrum that full subscriptions often fail for many consumers to return the full value of the cost of said subscriptions. We have found that, similarly, what we call “sub-subscriptions” or the ability of users to access all content by a given producer, or in a given subject, or with certain keywords, or some combination or similar filtering may also lead to the problems associated with full subscriptions. Therefore, an advantage of one or more embodiments of our invention is the ability for a user to very carefully and judiciously choose the content to which they have access to in a very selective and refined “sub-subscription;” in other words, one or more embodiments enable the user to produce a filtered list of content that they unlock which enables a very useful selection of content for that user.

Still another advantage of one or more aspects of one or more embodiments is the unappreciated advantage of creating a virtual economy. As is apparent through the detailed description of one or more embodiments, the embodiments enable people to earn a living without the concomitant capital expenditure that often accompanies traditional jobs. Instead of office space, travel, commuting costs, and so forth, one or more aspects of one or more embodiments frees people to work when they want, where they want, as much as they want. Also, some of the best journalism is done in environments without infrastructure, and one or more embodiments in this document facilitate off-site publishing.

Yet an additional advantage of one or more embodiments is the unappreciated advantage of enabling of people to create status for themselves. As is apparent through the detailed description of one or more embodiments, the embodiments allow people to create their own status and celebrity by publication and promotion of their work. Many people search for means to increase their social regard and one or more embodiments of these inventions enable that social improvement.

Another advantage of one or more embodiments is the solution of a long-felt need. As mentioned previously, newspapers, for example, are finding it difficult to earn a living in the age of the internet. For the past 10 or more years, revenues for newspapers have declined. One or more embodiments of the inventions allows for newspapers, and others whose paradigm has changed in the digital age to now make money directly from their content in a new and novel way. Instead of subscriptions or advertisements, newspapers, for example, earn directly from their content rather from the space around it.

Still an additional advantage is the synergistic effect of combining a publishing platform directly with a marketplace, with or without with additional embodiments as described herein. Although publishing platforms and means are known in the art, and marketplaces date back to the dawn of civilization, the combination of the two creates a synergistic effect which makes the whole more than the sum of its parts. This synergism comes from solving the traditional hurdles associated with both the publishing platform and the marketplace are solved by the other. For example, we believe we are the first to realize that one problem with publishing platforms is their disparity; many platforms exist which are located digitally, geographically, or physically separated from each other. Combining publishing platforms, in other words, a means to disseminate information, in a single marketplace helps solve this problem we found. This can be accomplished variously, including by using native publication means of the platform or by taking separate publications and integrating them into the marketplace. For example, a blogger might write a post into the platform using the tools we provide, yet their content would be displayed side-by-side with an article published in the New York Times which has been uploaded into the platform separately. Thus bringing multiple sources of content into a single platform helps solve the disparity issue we discovered. Similarly, marketplaces suffer, as economists can attest, when supply and demand are not well matched. One way to solve this is to bring the supply, in one embodiment the publishing platform, directly in contact with the demand, for example, consumers who want to read or otherwise consume the content. Additionally, if users are creating content, they often become consumers since they are already present on the platform; thus, a supplier becomes a demander. For example, a blogger who writes about politics might want to consume the latest news stories about politics, turning that information around in a think-piece on the same network from which the information was gleaned. We recognized that a combination of publishing platform and marketplace would solve the problem of a mismatch of supply and demand in a marketplace.

These and other advantages will become apparent through a full review of this application.

### BRIEF DESCRIPTION OF THE DRAWINGS

FIG. 1 is a schematic of the operation of one embodiment, representing the flow of information and money as enabled by a website encoded onto a server and communicating with computers from a plurality of users.

FIG. 2 is a schematic of the operation of one embodiment, representing the flow of information and money as enabled by a website encoded onto a server and communicating with computers from a plurality of users, said embodiment also enabling users to communicate with each other in a social network as well as describing the operation of an embodiment of a bank system to transfer monies between site-users.

FIG. 3 is an example of an embodiment where users can enter unformatted content into a website to enable the website to easily format the content for the user.

FIG. 4 shows some functionality in FIG. 3, the ability to add pictures or other files into a content.

FIG. 5 shows content entered into the form of FIG. 3 and illustrates an embodiment of how one might optionally set a price for content that others must pay to view that content.

FIG. 6 shows an example of an embodiment of how formatted content might appear as a preview of the entire content.

FIG. 7 shows an example of an embodiment of how formatted content might look as a full article.

FIG. 8 shows an example of an embodiment of a feed of content one might be able to peruse.

FIG. 9 shows the detail of an embodiment which shows a preview for a written article which costs money to purchase.

FIG. 10 shows an embodiment of how one might comment on a piece of content.

FIG. 11 shows an embodiment of how one might be able to view comments written by others on a piece of content.

### LIST OF REFERENCE NUMERALS OF DRAWINGS

102 Content creator
104 content
106 computer system
108 publishing platform
110 end-user
112 content
114 monies
116 marketplace
118 monies
202 content creator
204 content
206 computer system(s) configured to format content
208 formatted content
210 marketplace website
212 content reader or end-user
214 credits
216 money
218 computer system(s) configured to act as a way to transfer money
220 credits
222 credits
224 computer system(s) configured to facilitate interactions amongst end-users in a social network
226 credits
228 computer system(s) configured to act as a way to exchange money for site credits
302 entry field
304 optional message
306 buttons
308 hashtag field
310 field for photo attachment
312 field for entry of body text
314 button(s) to format text
316 field indicating number of words
318 field to enter cost or price of content
320 field to submit content to formatting computer system
322 field to allow saving of content
402 field to select and upload a picture, video, animation, or other media
802 content
804 content
806 content
808 content
810 content
902 title
904 picture
906 text
908 button to allow ranking and or rating
910 button to allow access
912 field displaying price of content
1002 field to allow text entry
1004 button to attach text
1102 example of comment

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

One embodiment is a website which enables a content producer, content creator, author, writer, artist, or creator, which can be a single human or an entity such as a newspaper, to easily publish and to easily sell content, written works, pictures, opinions, blogs, musings, predictions, visions, religious and philosophical writings, fictional pieces (including short stories or novel chapters), erotic writings, historical notes, videos, multimedia presentations, audio files, or any combination thereof. The website contains the needed programming stored on a computer hardware system to enable content producers to easily and simply enter content (for example, text and pictures comprising a blog entry), to then automatically or within the control of the content creator format said content into a clean, organized, customizable or automatically generated output; enable this now-formatted content to be shared in a place where other people or entities can see the content; enable the content to be bought by consumers, end-users, or site-users, which might be in one or more embodiments other content producers; and allow for the exchange of money associated with the sale and purchase of the content; see OPERATION below. The programming can be stored on a server using known programming means such as HTML, CSS, Java, Python, Django, C++, Perl, .net, Ruby, Rails, PHP, or any other convenient language or combination of languages as is well known in the art. Although it is imagined that the content producer will use a computer to access a website to produce, enter, and list the content in the marketplace; a second computer or server will host the content for browsing by end-users; a third computer will link to the content and control the information flow of rights to access the content, cost of the content, exchange of money, and other metadata; while an end-user will use a fourth computer to access, preview, retrieve the content, and enter information for metadata purposes including exchanging money for the content, it is feasible that as few as one computer could serve the purposes of all tasks of this embodiment. For example, a content producer and an end user might login to a centralized computer system which allows content to be produced, hosted, exchanged, metadata hosted, and money exchanged. One embodiment thereby enables end-users to access individual content which for example might normally only accessible by subscription (e.g. within a newspaper or magazine or website requiring a subscription). One embodiment thereby creates a marketplace where end-users can access content they want without having to also pay for content they do not want. This embodiment also enables content creators to publish, publicize, and then earn money for their content based on the number of end-users who decide to purchase that content.

In another embodiment, the content creators, or end-users, or any combination (collectively termed “site-users”) are connected via a social network to each other. This social network is familiar in the current art but certain embodiments can include features such as enabling site-users to:
interact with each other via messaging
post comments onto content or sections of content (similar to Sound Cloud)
rate articles
direct message with other site-users
create a profile which provides information about the site-user in the account if desired, including profile photo(s), text, external link(s), and so on,
provide a list of content created by the site-user, or a list of content that the site-user has otherwise interacted with (comments, etc.)
“follow” each other, to:
   o see other site-users' updates
   share and exchange messages and article previews or full articles
   share a preview of article content directly to other site-users or entities not using the site
regardless of whether the users are known to each other or not
purchase digital content(s) in advance, then send that content (instead of a preview) to others site-users directly
   optionally, incorporating other features of the “social network” as discussed herein along with this “gift”
Reply directly to another user's comment
And other features common to social networks but also unique to the logistics of the envisioned embodiment.

In another embodiment, the end-users can select certain content, or content from certain content publishers, or a selection of content from a selection of content publishers, to be “subscribed” to in part or whole, which means that this content will be delivered directly to them either by email, or on a specific webpage associated with that user, or other methods known in the art. This embodiment thereby enables the end-user to “sub-subscribe” to content, for example, to receive only the sports section from the local newspaper. One advantage of this embodiment is the enabling of end-users to receive only content they want, and thereby build a repository of information they have curated for themselves. In one embodiment, this repository appears to be a pre-made “newspaper” of content specifically chosen by the end-user. For example, an end-user may want the local sports news, entertainment news from a Hollywood source, comedic writings from Dave Barry, and weather reports from NOAA. How a site-user might choose what content is selected, and algorithms to display pre-selected content is configurable using methods well known in the art so that the site-user can customize what content is displayed to them. This sort of delivery is often termed a “feed” in the art; it can also be referred to herein as a customizable newspaper, customizable homepage, or landing page. Thus, one embodiment allows end-users to create their own feed of content, which has been paid for, which is free, or which would require payment.

Another embodiment allows end-users to fill a feed with content, but without pre-paying for that feed. Thus, in one embodiment, the webpage associated with the end-user is populated automatically based on the choices of the end-user, but no content has yet been purchased.

In yet another embodiment, a site-user has login credentials similar to other websites and so forth and well known in the art. Thus, in this embodiment, the site-user can access content from a variety of sources with a single set of login credentials, dramatically easing the access to content.

Another embodiment provides a short preview of content on the computer screen to site-users. Thus, a site-user may be able to ascertain what a given piece of content may contain prior to reading or purchasing said content.

An additional embodiment allows content to be displayed without advertisements. This provides a much more clean looking experience for site-users.

In a further embodiment, site-users, be them content creators or end-users, can link to externally-hosted content. Although this embodiment may stand alone, especially when combined with the social networking embodiment as described above, the external linking allows site-users to share content with other site-users to discuss it, comment on it, and so forth.

In still another embodiment, site-users can select content, and that content can be displayed in a feed associated with that site user. This embodiment enables site-users to create curated feeds. Although this embodiment may stand alone, especially when combined with the social networking embodiment as described above, the curated feed allows users to follow what appear to be custom newspapers, etc., associated with a given user.

An additional embodiment provides search features as known in the art. Site-users may therefore discover content by author name, keywords, locations, and other search terms well known in the art. This embodiment enables site-users to find content and helps content creators sell or otherwise disseminate their content.

In a further embodiment, the website can be configured to store content from content producers for indefinite periods of time. Therefore, this embodiment can serve as a storage method for content producers or site-users to easily log, store, or cache information.

An additional embodiment is a location where humans can access the necessary space and supplies required to produce writing, drawings, paintings, stencils, animations, calligraphy, ceramics, collage, furniture, installations, jewelry, mosaics, photography, prints, sand art, stained glass art, tapestry art, where said location allows for other humans to browse said works and purchase them directly from the human who created the work, thereby combining a location to produce and sell content in a single marketplace.

These embodiments may be variously combined with each other, producing additional benefits through synergism.

Thus, the reader will see that at least one embodiment of this publishing method and marketplace provides for the ability for content producers to directly publish their work and earn directly for that work, and for consumers or end-users to consume content from the content producer directly, while only seeing and paying for the content they want. This and other advantages are summarized in the ADVANTAGES section of this document. While the above description contains many specificities, these should not be construed as limitations on the scope, but rather as an exemplification of one [or several] embodiments thereof. Many other variations are possible. Accordingly, the scope should be determined not by the embodiment(s) illustrated, but by the appended claims and their legal equivalents.

### Operation

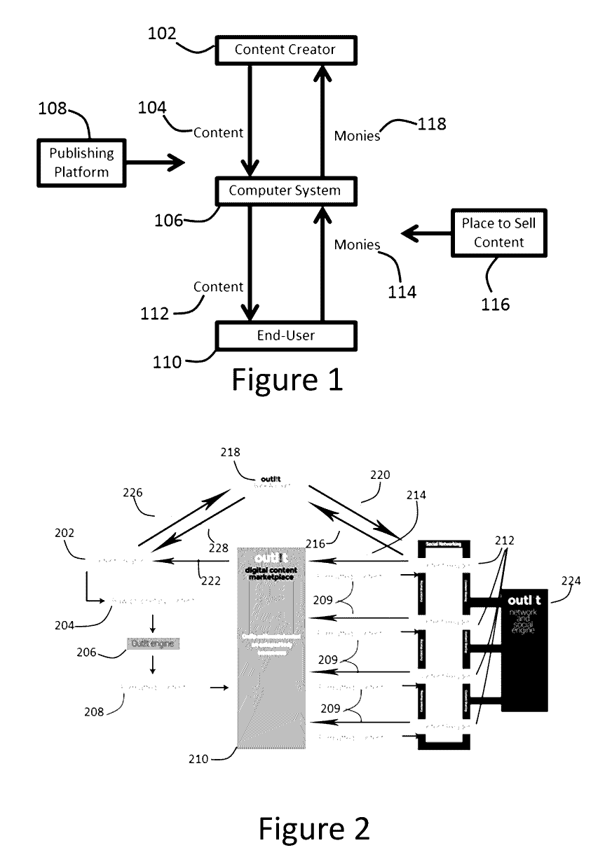

FIG. 1 is a diagram of one embodiment of the invention. A content creator 102, content producer, content creator, author, writer, or creator, which may be a single person, a collection of people, an company, a computer, or other entities, enters content 104, which can be written works, pictures, opinions, blogs, musings, predictions, visions, religious and philosophical writings, fictional pieces (including short stories or novel chapters), erotic writings, historical notes, videos, multimedia presentations, audio files, or any combination thereof, into computer system 106 by any means well known in the art. Thus, the process of content creator 102 entering content 104 into computer system 108 comprises a publishing platform 108. End-user 110, also known as content readers, site-users, or consumers which can be a single human, a collection of people, a company, a computer, or other entities, can see content 112, which can be identical to content 104 or optionally altered by computer system 106 to be formatted in a pleasing and useful manner, in exchange for monies 114 which is added, transferred, denoted, credited, or otherwise entered by many known means in the art into computer system 106 in exchange for content 112. Thus, the exchange of monies 114 from end user into computer system 106 in exchange for content 112 comprises a place to sell content 116, also known as a marketplace, market, bazaar, exchange, digital economy, digital marketplace, digital market, digital bazaar, and so forth. When end-user exchanges monies 114 for content 112, computer system 106 substantially transfers some or all of monies 114 as monies 118, which can be identical to, a subset of, or more than monies 114 entered by end-user to content creator 102. Thus, the entering of content 104, and receipt of monies 118 constitutes a way for content creators to earn directly for their content. In some embodiments, computer system 106 is a collection of disparate computers linked together. In some embodiments, the computers comprise processors, memories, buses, methods of entering data, storing data, and retrieval of data. In some embodiments, computer system 106 is a server system configured to communicate with one or more computers located adjacent or remotely with other computer systems. In some embodiments, computer system 106 can comprise a computer system for the content producer communicating with a central computer system which also communicates with a computer system for the end-user.

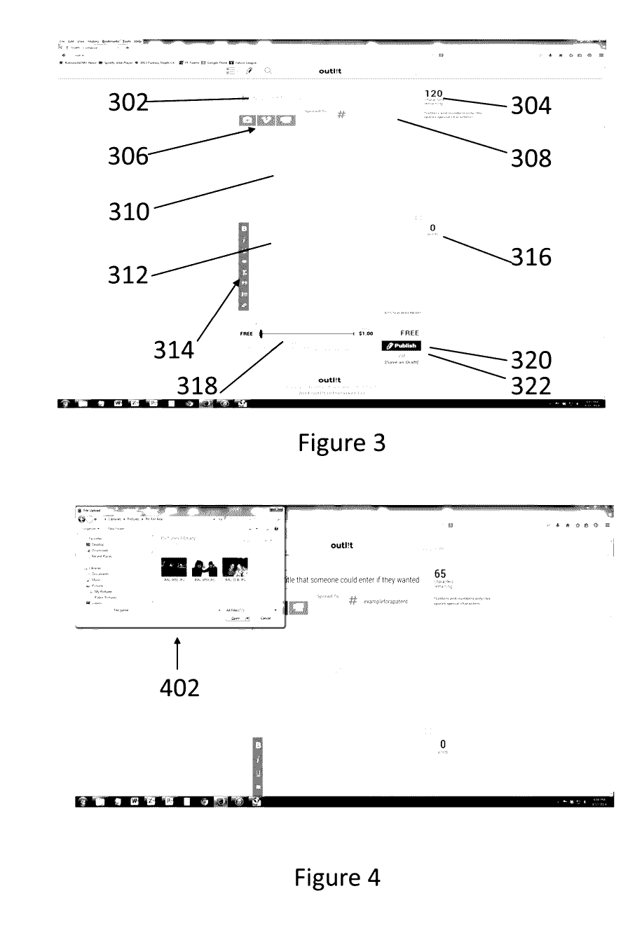

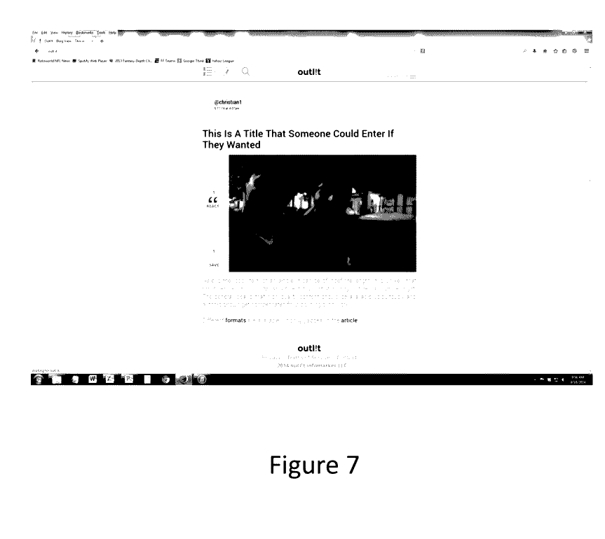

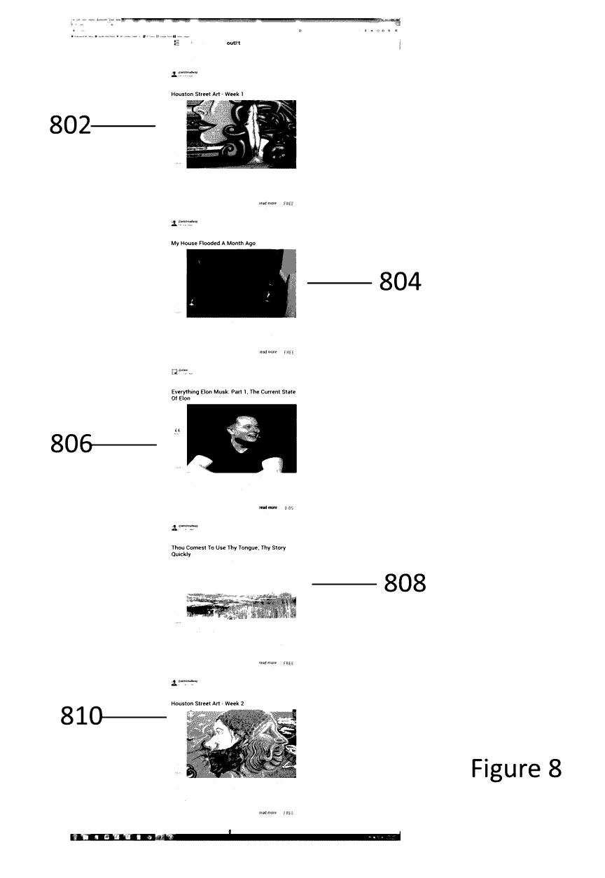

FIG. 2 is a diagram of the layout for an embodiment, in this example configured as a systems of computer connected to each other, optionally via the internet, the central computer systems of which are in this embodiment configured to display and operate as a website called “Out1!t.” A content creator 202 which may typically be a person but which could also be a machine or group of people or other entities, and of which there may be multiple simultaneous creators, with only one shown in this figure for simplicity, takes raw, unformatted and proprietary content 204 and enters it into one or more computer systems configured to store, allow retrieval of, and to format content, in this figure, labeled “Out1!t engine” 206. For example FIGS. 3 through 5 show a method for content entry configured for a human to easily use. In the embodiment shown in FIG. 2, the website Out1!t embodiment has an engine 206 which is a series of processes and code programmed into a computer which takes the raw content 202 and produces a formatted content 208, an example of an embodiment of which can be seen as FIGS. 6 and 7. The formatted content 208 is then made available by computer manipulation of data on the website marketplace 210, an example of how such a marketplace might be presented on a web page is shown in FIG. 8. Content reader 212, also known as end-users, consumers, or site-user, shown in this embodiment as several separate entities, but which could be a single entity, said content readers being a human, collection of humans, a computer, a machine or other entities, can see, observe, read, download, retrieve, or otherwise consume formatted content 209, which can be identical to, a subset of, or an augmentation of formatted content 208, as well as, optionally, content different from formatted content 208, not pictured in this description, on marketplace 210 and optionally give credits 214, also called digital money, digital currency, and so forth, which can be a representation of real, legal tender, in exchange for formatted content 209. In order to obtain credits 214, content reader 212 transfers by known means and methods real currency, legal tender, digital representations of legal tender, or money 216 to a bank engine 218—which is a series of processes and code programmed into a computer to enable the conversion of real currency to digital credits representing real currency, or which tracks and accounts for digital representations of currency by known means, for credits which can be exchanged between content readers and creators in exchange for a predetermined number of credits 220. For example content reader 212 and content creator 202 could give credits to each other within the website as labelled in this figure as Out1!t or content reader 212 can transfer credits 214 to content creator 202 directly, or vice versa, or both. If content reader 212 retrieved formatted content 209 from digital marketplace 210, and formatted content 209 was substantially identical to, a subset of, an augmentation to and using content 208, or even a version of content 208, including copyrighted versions or derivations thereof, content creator 202 would receive credits 222, which could be identical to, a subset of, or an augmentation to credits 214. In some embodiments, content reader 212 can interact with other content readers 212 through optional social engine 224, which is a series of processes and code programmed into one or more computers, or a network of computers configured to allow content readers to interact with each other, including, optionally, content creator(s) 202. In some embodiments, content creator 202 could be content reader 212 and vice versa. In some embodiments, content creator 202 or content reader 212 or both are free to give money 216 to the Out1!t bank in exchange for credits 220 at any time, and also can give credits 226 to the bank and recieve real currency (money) or digital representations thereof which are easily exchanged for real currency or legal tender by known means 228 respectively, optionally with a predetermined exchange rate for currency and credits. Thus, the embodiment(s) depicted in FIG. 2 constitute a means for publishing and a marketplace to exchange that published content for money.

FIG. 3 shows one embodiment for how unformatted content can be entered into the engine as described above for formatting. An optional title can be entered into entry field 302 with optional message 304 indicating the remaining or needed characters, if required. Buttons 306 can operate code in the computer system(s) to optionally allow for integration with other social media sites such as Facebook, Twitter, etc. Optional field 308 allows for a hashtag to be included with the post. Field 310 allows for optional attachment of a photo, clicking which brings up, for example, field 402 to allow attachment of a picture as shown in FIG. 4. Alternative, field 310 allows the direct capture of a photograph or video from the device being used, for example, the camera on a smartphone. Field 312 allows for optional entry of the body text of the content, with optional buttons 314 enabling formatting of text and field 316 indicating the number of entered words or remaining words if there is a limit. Field 318, shown here as a sliding bar, but which could be any convenient means, allows the content creator the option of publishing the content with any arbitrary value from free to a predetermined limit, which is shown as an example in this embodiment as $1. The content creator can use field 320 to submit the content to the formatting engine as discussed in FIG. 2, which is shown in this embodiment using a button but which could be any convenient feature. Optional field 322 allows the user to save their content without publishing it, often referred to as saving a draft; in other words, the content is stored on a computer but not available for others to consume. These features and fields are generally coded by known means into a computer system. Some or none of these features and others may be useful in one or more embodiments.

FIG. 4 shows an example of an embodiment when field 310 is clicked, allowing field 402 to be used to select a picture, video, animation, or other type of media to be attached to the content. These features and fields are generally coded by known means into a computer system.

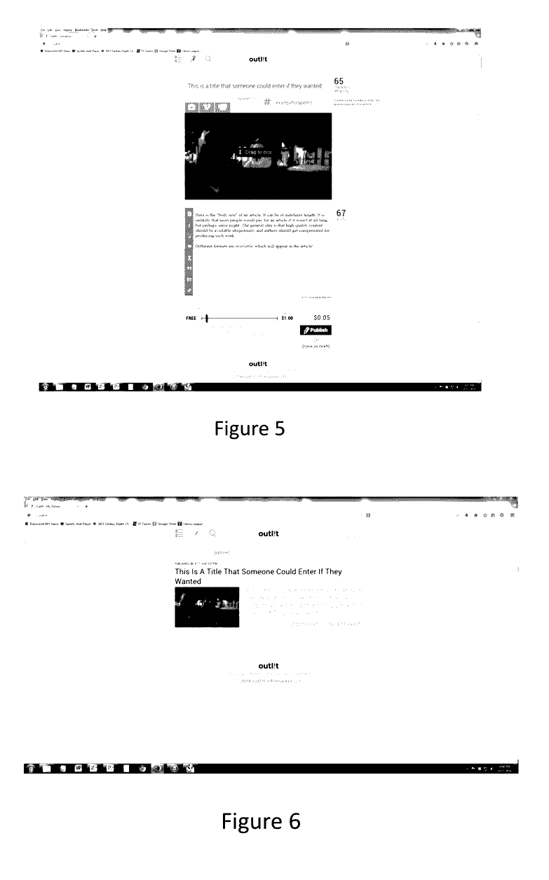

FIG. 5 shows an example of an embodiment where content has been entered but prior to submitting to the formatting engine. These features and fields are generally coded by known means into a computer system.

FIG. 6 shows an example of an embodiment after material has been published. Note that part of the text is displayed as a preview of the content in the rest of the main body of the article. These features and fields are generally coded by known means into a computer system.

FIG. 7 shows an example of an embodiment of what the formatted content, in this case an article with a title and picture and some text, looks like. FIG. 6 would be an example of formatted content 208 and/or 209 in FIG. 2. These features and fields are generally coded by known means into a computer system.

FIG. 8 shows an example of an embodiment of how marketplace 210 might look on a website. For this example, several windows of the web page were stitched together into a single image to show that one might be able to scroll down on a webpage to see other content with images, written preview, options to buy, and other information about the formatted content. On certain devices, one might be able to scroll or swipe right or left to view other content or information about the content, or to interact with other users, or to edit personal information, or any other function which is pertinent to the function of the marketplace or user. Content 802, 804, 806, 808, and 810 could be examples of content 208 or 209 in FIG. 2. These features and fields are generally coded by known means into a computer system.

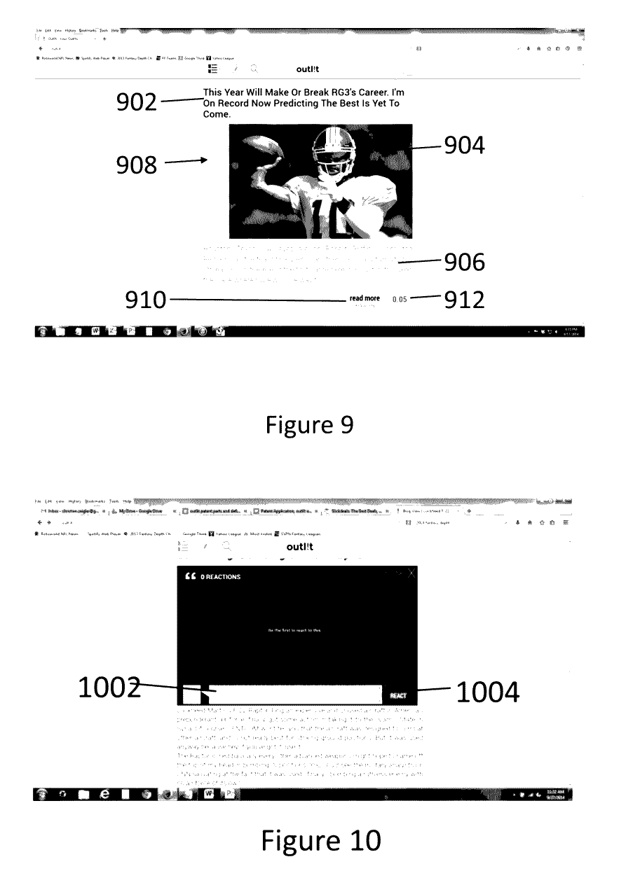

FIG. 9 shows detail from an example of an embodiment showing content similar to that shown in FIG. 8. Title 902 and picture 904 are optionally shown, along with optional body text 906. Optional buttons 908 allow ranking and rating of the article, picture, or text, optional citation or quotation of the text, or other optional functionalities. Optional button 910 allows one to access the content, and optionally field 912 displays a price for the content. Using optional button 910 would allow content reader 212 in FIG. 2 to exchange credits 214 for formatted content 209, where formatted content 209 in FIG. 2 is represented or previewed by optional title 902, optional FIG. 904, and optional text 906 in FIG. 9. These features and fields are generally coded by known means into a computer system.

FIG. 10 shows an embodiment of how one might comment on a piece of content. Field 1002 optionally allows one to enter text with optional button 1004 allowing that text to be digitally attached to the content. These features and fields are generally coded by known means into a computer system.

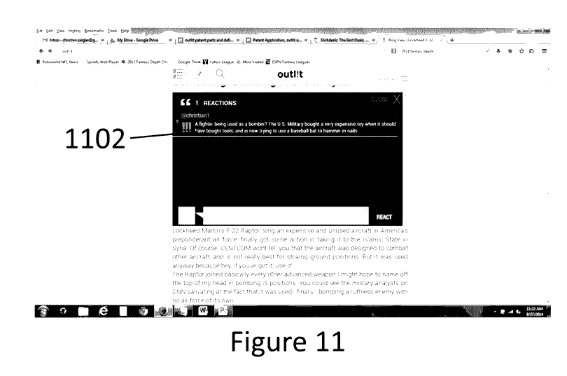

FIG. 11 shows an embodiment of how one might be able to view comments written by others on a piece of content. Text 1102 shows an example of the comment written as illustrated in FIG. 10. These features and fields are generally coded by known means into a computer system.

What is claimed is:

1. A computer-implemented method for providing a way to create and publish content and a marketplace to exchange monies for content, the method comprising:
a. providing a computer implemented means for entering content,
b. providing a computer-readable storage medium for storing said content,
c. providing a computer implemented means for accepting monies from one party and substantially transferring the monies to another party,
d. providing a computer-implemented means of transmitting and displaying said content from the storage medium,
e. providing a computer-implemented means for associating said transfer of monies with said transmitting of content,
whereby such a method allows any parties to create, buy, and sell content directly to and from one or more other parties.

2. The method of claim 1, wherein a human enters said content.

3. The method of claim 1, wherein monies are accepted from a human.

4. The method of claim 1, wherein monies are transferred to a human.

5. The method of claim 1, wherein said content is transmitted and displayed to a human.

6. The method of claim 1, wherein such a method includes a computer implemented method for entities selected from the group of said entities that enter content, and that receive content, to interact with each other beyond the exchanging of content and monies, such interaction selected from the group of sending messages to each other, sending pictures and videos to each other, providing information about the entities to each other, providing information about the action of the entities in said marketplace to each other, and allowing entities to create groups of other entities storable and retrievable from a computer readable storage medium, whereby such interaction comprises a social network between entities to facilitate interaction between entities and encourage participation with content, thereby possibly increasing engagement and value of content in the marketplace.

7. The method of claim 1, wherein such a method includes a computer implemented method allowing entities that receive said content to pre-select content that originates from one or more specific entities, whereby such a method allows entities that receive content to subscribe to content from sources of their choosing.

8. The method of claim 1, wherein such a method includes a computer implemented method allowing entities that receive said content to pre-select content that matches a certain set of selected key words, from one or more specific entities, whereby such a method allows entities that receive content to subscribe to content associated with certain subjects or themes of their choosing.

9. The method of claim 1, wherein such a method includes a computer implemented method allowing for aggregation and organization of content, the system comprising
a. A computer implemented method for aggregating, organizing, and storing said content as chosen by entities that receive said in a computer-readable storage medium, and
b. A computer implemented method for retrieving said content, when chosen by entities that receive said content from said computer-readable storage medium
whereby such a method allows entities to collect, store, organize, aggregate, and assemble content from disparate sources in a single location.

10. The method of claim 1, wherein such a method includes a computer implemented method for accessing said content in a secure manner, whereby such a method enables unique and private set of credentials to be used to access and purchase content even from disparate sources.

11. The method of claim 1, wherein such a method includes a computer-implemented method for displaying a portion of said content, whereby such a method enables entities to preview content prior to purchasing it.

12. The method of claim 1, wherein such a method includes a computer-implemented method for preventing facile computer character copying of the text, whereby such a method prevents entities from selecting text and copying it to circumvent the purchasing of content by other entities.

13. The method of claim 1, wherein such a method includes a computer-implemented method using an algorithm for calculating the price associated with given content.

14. The method of claim 1, wherein such a computer implemented method includes one or more computer implemented methods selected from the group of claim 6, claim 7, claim 8, claim 9, claim 10, claim 11, claim 12, and claim 13.

15. A machine which allows a way to create and publish content and a marketplace to exchange monies for said content, the system comprising:
f. a computer implemented means for entering content,
g. a computer-readable storage medium for storing said content,
h. a computer implemented means for accepting monies from one party and substantially transferring the monies to another party,
i. a computer-implemented means of transmitting and displaying said content from the storage medium,
j. a computer-implemented means for associating said transfer of monies with said transmitting of content,
whereby such a machine allows any parties, humans, companies, other machines, computers, or entities to create, buy, and sell content directly to and from one or more other parties.

16. The machine of claim 15, wherein a human enters said content.

17. The machine of claim 15, wherein monies are accepted from a human.

18. The machine of claim 15, wherein monies are transferred to a human.

19. The machine of claim 15, wherein said content is transmitted and displayed to a human.

20. The machine of claim 15, wherein such a machine includes a computer implemented method for entities selected from the group of said entities that enter content, and that receive content, to interact with each other beyond the exchanging of content and monies, such interaction selected from the group of sending messages to each other, sending pictures and videos to each other, providing information about the entities to each other, providing information about the action of the entities in said marketplace to each other, and allowing entities to create groups of other entities storable and retrievable from a computer readable storage medium, whereby such interaction comprises a social network between entities to facilitate interaction between entities and encourage participation with content, thereby possibly increasing engagement and value of content in the marketplace.

21. The machine of claim 15, wherein such a machine includes a computer implemented method allowing entities that receive said content to pre-select content that originates from one or more specific entities, whereby such a machine allows entities that receive content to subscribe to content from sources of their choosing.

22. The machine of claim 15, wherein such a machine includes a computer implemented method allowing entities that receive said content to pre-select content that matches a certain set of selected key words, from one or more specific entities, whereby such a method allows entities that receive content to subscribe to content associated with certain subjects or themes of their choosing.

23. The machine of claim 15, wherein such a machine includes a computer implemented method allowing for aggregation and organization of content, the system comprising
a. A computer implemented method for aggregating, organizing, and storing said content as chosen by entities that receive said in a computer-readable storage medium, and
b. A computer implemented method for retrieving said content, when chosen by entities that receive said content from said computer-readable storage medium
whereby such a machine allows entities to collect, store, organize, aggregate, and assemble content from disparate sources in a single location.

24. The machine of claim 15, wherein such a machine includes a computer implemented method for accessing said content in a secure manner, whereby such a machine enables unique and private set of credentials to be used to access and purchase content even from disparate sources.

25. The machine of claim 15, wherein such a machine includes a computer-implemented method for displaying a portion of said content, whereby such a machine enables entities to preview content prior to purchasing it.

26. The machine of claim 15, wherein such a machine includes a computer-implemented method for preventing facile computer character copying of the text, whereby such a machine prevents entities from selecting text and copying it to circumvent the purchasing of content by other entities.

27. The machine of claim 15, wherein such a machine includes a computer-implemented method using an algorithm for calculating the price associated with given content.

28. The machine of claim 15, wherein such a computer implemented method includes one or more computer implemented methods selected from the group of claim 20, claim 21, claim 22, claim 23, claim 24, claim 25, claim 26, and claim 27.

29. A computer-implemented method for providing a way to circulate content and an economic forum to exchange monies for content, comprising:
a. providing a computer implemented means allowing a first entity to enter data into a computer readable storage medium,
b. providing a computer implemented means for collecting said data and creating a unit of content which contains said data,
c. providing a computer implemented means allowing a second entity to give money to said first entity in exchange for access to said unit of content, whereby such a method allows any entities to variously create, buy, and sell content directly to and from one or more other entities.

30. A machine for providing a way to circulate content and an economic forum to exchange monies for content, comprising:
d. a computer implemented means allowing a first entity to enter data into a computer readable storage medium,
e. a computer implemented means for collecting said data and creating a unit of content which contains said data,
f. a computer implemented means allowing a second entity to give money to said first entity in exchange for access to said unit of content,
whereby such a machine allows any entities to variously create, buy, and sell content directly to and from one or more other entities.

31. A computer implemented method for creating an online digital content publishing marketplace, the method comprising:
a. providing a computer implemented method for a first user to enter digital content, and
b. providing a computer implemented method for other users to exchange money with said first user in order to access the content
whereby such a method provides a digital marketplace for exchanging of content between users in exchange for money.

32. A machine providing both a way for humans to create and publish digital content, in addition to a marketplace for humans to exchange monies for digital content, the system comprising:
a. a computer implemented means for providing a space for a human to enter digital content,
b. a computer-readable storage medium for storage of said digital data,
c. a computer implemented method using one or more computer systems which provides the means to accept monies from one person and substantially transfer the monies to another human, the process of which allows said person who purchased digital content to receive said digital content from said user who entered and sold said digital content,
whereby such a method allows humans to create, buy, and sell digital data directly to and from one or more other humans.

33. A computer implemented method for creating a content marketplace, the means comprising
a. providing a computer-implemented means for entering content, and
b. providing a computer implemented means for exchanging exchange money between entities for said content
Whereby such a method allows entities to create and sell content directly to other entities.

34. A computer implemented method for providing a marketplace for digital content, the system comprising: providing a computer implemented method using one or more computer systems enabling means to accept monies from one party and substantially transfer the monies to one or more other parties, the process of which allows the party that purchased digital content to receive said digital content from the party that sold said digital content, whereby such a method allows humans to buy and sell content directly to and from one or more other humans.

35. A computer implemented method for providing a marketplace for digital content, the system comprising:
a. providing a computer implemented database comprising:
i. a plurality of Internet addresses that point to the location of digital content where each Internet address points to a specific set of digital content hosted at one or more digital content hosts;
ii. data associated with each of said internet address which identifies the content creator of said digital content, the cost to retrieve said digital content, and a list of end-users who have the permission to retrieve said digital content;
b. providing a computer implemented method using one or more computer systems which provides the means to accept payment from one party and substantially transfer the payment to one or more other parties, the process of which updates said list of end-users who have the permission to retrieve said content and thereby permits the end-user to retrieve said digital content produced by said content creator from the internet address associated with said content
whereby such a method allows humans to buy and sell content directly to and from one or more other humans.

36. A computer implemented method of providing a combined way to publish with ability to sell digital content, the method comprising:
a. providing a computer implemented means to enter content, as performed by a content creator
b. providing a computer-implemented means to store and retrieve said content
b. providing a computer implemented database which associates metadata of the content including price and permission for one or more end-users to access the content
c. providing a computer implemented means for said end-user to retrieve all or part of said content
d. providing a computer implemented means for said end-user to substantially transfer monies to said content creator, which communicates with said database and said retrieval system to grant permission for said end-user to retrieve content
Whereby such a method enables people to enter content and other people to purchase content by associating the transfer of monies from one to the other with the transfer of permission to retrieve content, thereby creating a publishing platform integrated with a digital content marketplace.

37. A computer-implemented method of publishing digital content in a predetermined format for a device, the method comprising:
a. providing a computer implemented means for obtaining raw digital content including pictures, text, videos, sounds, music, and the like from a content publisher and storing in a file for raw digital content, said file possibly also containing other data;
b. providing a computer implemented means for identifying reading device attributes and storing in a file for reading device attributes, said file possibly also containing other data;
c. providing a computer implemented means for obtaining meta-data which determines a predetermined layout of content and storing in a file for meta-data of content layout, said file possibly also containing other data;
d. providing a computer implemented means for determining a device-specific font size for the raw content based on the reading device attributes by retrieving and using said meta-data;
e. providing a computer implemented means for determining reading device-specific size for pictures and videos by retrieving and using reading device attributes data stored in said file for reading device attributes;
f. providing a computer implemented means for determining reading device-specific modes of reproducing video, sounds, music, and the like;
g. providing a computer implemented means for determining a width for one or more page columns and the number of available column rows within the screen of the reading device based on the column width as calculated from reading device attributes retrieved from said file for reading device attributes;
h. providing a computer implemented means for automatically populating the page columns with the digital content retrieved from said file for raw digital content to generate a reading device-specific digital publication in a predetermined format for display on the device,
i. providing a computer implemented means for sending the publication to the device;
whereby such a method enables a human to publish digital content in a predetermined, pleasant, and organized format for reading, watching, using, observing, listening, and seeing by other humans using unformatted raw content.

38. A computer-implemented method for enabling communication between users of a website, the method comprising:
a. providing a computer implemented means for a database comprising a list of user information including online identifiers such as names as well as a list of content items to which the users have access;
b. providing a computer implemented means for for a plurality of users of a website to exchange information such as written text, audio or video files, photographs, and other digitally encoded media with each other,
c. providing a computer implemented means for said information exchange to occur either in or out of the context of a given content item as specified by the users who are engaging in the information exchange, the content item being indicated to users who are communicating by an appropriate computer implemented method for displaying this information;
whereby humans can interact in an online social network in the context of information to which at least one human has access.

39. A computer-implemented method of modifying a digital text reader software within a computer-implemented operating system to constrain text copying, the method comprising providing a computer implemented means of incorporating additional algorithms in the digital text reader software which prevents text from being selected as characters and copied within the operating system of the device,
whereby such a method allows readers who can physically observe text to not be able to use the normal internal operating characteristics of the digital text reader device to select this text and copy it for use in other locations as text comprising of resolved characters which can be edited.

40. A computer implemented method for determining the price of digital content, the method comprising
a. providing a computer implemented database containing metadata about said digital content
b. providing a computer implemented means which uses said metadata to calculate a relative score for each piece of digital content
c. providing a computer implemented means to allow each score for digital content to be associated automatically or through a user input with a price for said digital content
whereby such a method enables a way to automatically determine the price of content based on any metrics of convenience and thereby allows digital content to be priced competitively and relative to other pieces of digital content.

41. A computer implemented method for determining the price of digital content, the method comprising:
a. providing a computer implemented means for a human, machine, computer, company, a piece of software, or another entity to select a price
b. providing a computer implemented means for said price to be associated with said piece of digital content
whereby such a method allows users to individually price content in a marketplace and adjust that price as they see fit to match the demand for their content offering with the price or supply of that offering.

42. A creative marketplace comprising:
a. providing a means for a human to produce creative pieces of art selected from the group of writing, art works, sculptures, drawings, paintings, stencils, animations, calligraphy, ceramics, collage, furniture, installations, jewelry, metalwork, mosaics, photography, prints, sand art, stained glass art, tapestry art, and
b. providing a means for said human to sell said creative pieces in the same location at which the creative pieces were produced,
whereby such a marketplace provides both a place to produce and to sell a creative piece of work directly, thereby enabling artists, writers, and so forth to earn a living without having to provide their own means to produce said creative pieces.
